(19) United States
(12) Patent Application Publication
(10) Pub. No.: US 2014/0150937 A1
(43) Pub. Date: Jun. 5, 2014

(54) AIR-CUSHIONED VEHICLE COVER

(71) Applicant: LetltHail, LLC, Sapulpa, OK (US)

(72) Inventor: Lawrence A. Favalora, III, Oilton, OK (US)

(73) Assignee: LetltHail, LLC, Sapulpa, OK (US)

(21) Appl. No.: 14/096,679

(22) Filed: Dec. 4, 2013

Related U.S. Application Data
(60) Provisional application No. 61/733,026, filed on Dec. 4, 2012.

(51) Int. Cl. B60J 11/04

(52) U.S. Cl. CPC B60J 11/04
USPC 150/166

(57) ABSTRACT

An inflatable vehicle cover having a plurality of interconnected air cells prevents damage to a vehicle's surface that may result from the impact of hail, debris, or other objects on the vehicle's surface. The vehicle cover has a first layer positioned on the vehicle, the plurality of inflatable air cells formed in an array and positioned on the first layer, a second layer positioned atop the array of inflatable air cells, and an air access point located on at least one air cell for interconnecting the air cell with a source of air.

### RELATED APPLICATIONS

The present application is a non-provisional application and claims priority benefit, with regard to all common subject matter, of earlier-filed U.S. Provisional Patent Application No. 61/733,026, filed Dec. 4, 2012, and entitled “AIR CUSHION APPARATUS AND SYSTEM FOR COVERING AND PROTECTING VEHICLES.” The identified earlier-filed provisional application is hereby incorporated by reference into the present application in its entirety.

### BACKGROUND

1. Field

Embodiments of the invention are directed to an air-cushioned vehicle cover for covering cars, boats, motorcycles, and other types of vehicles. More particularly, embodiments of the invention are directed to a vehicle cover that fits tightly around the vehicle and includes a plurality of inflatable air cells that operate as a barrier to protect the vehicle from hail or other falling objects that may impact and damage the vehicle.

2. Related Art

Vehicle covers are frequently used to protect vehicles from sun and small particulates, such as dust and dirt, and comprise a single layer of material that is fitted over the vehicle. These vehicle covers do not provide much, if any protection, against objects that may impact the vehicle with a relatively large force, such as hail or large debris caused by a storm, such as tree branches or rocks. To address the problem of protecting the vehicle against large-force impacting objects, some vehicle covers provide an inflatable capsule or bubble that completely covers the vehicle. The capsule comprises a single large air chamber that covers a top surface of the vehicle and, in some instances, surrounds the vehicle on all five sides of the vehicle (i.e., top, front and back, and left and right sides). A disadvantage of the single large air chamber is that as objects impact the air chamber, the air within the chamber is easily pushed away from the impact area and distributed throughout the remaining space of the large air chamber. As a result, the objects are not entirely impeded by the air chamber, such that the vehicle cover provides effectively little protection from the object's impact. Additionally, these single air chamber vehicle covers consume a large amount of space when installed over the vehicle.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

Embodiments of the invention are a vehicle cover comprising a first layer configured for positioning proximal the vehicle and for contacting at least a portion of the vehicle; a plurality of inflatable air cells formed in an array, wherein each air cell is formed of a pliable material that is configured to be inflated with air to form an internal air chamber, wherein at least a first portion of the plurality of air cells are fluidly connected for the transfer of air through each of the first portion of the plurality of air cells, wherein at least a second portion of the plurality of air cells are fluidly connected for the transfer of air through each of the second portion of the plurality of air cells, wherein at least a portion of the array is coupled to and rests upon at least a portion of the first layer, such that the first layer serves as a substrate for said at least a portion of the array; an air access point located on at least one air cell of said at least a first portion of the plurality of air cells for interconnecting said at least one air cell with a source of air; and a second layer configured for positioning distal the vehicle and for facing an ambient environment in which the vehicle is located.

In embodiments of the invention, each air cell has a width, height, and length of less than 10 inches, such that a quantity of air cells for a vehicle cover is at least 100 air cells. A smaller-sized air cell results in less air movement within each cell upon the cell being impacted by an object at a large force. If air movement is limited within the air cell, the air then becomes a cushion for the object and prevents the object from impacting the underlying vehicle surface.

### BRIEF DESCRIPTION OF THE DRAWINGS

Embodiments of the present invention are described in detail below with reference to the attached drawing figures, wherein:

FIG. 1 is perspective view of a vehicle with a vehicle cover of embodiments of the invention covering the vehicle and a portion of the vehicle cover cut away to illustrate an array of inflatable air cells;

FIG. 2 is a fragmented perspective view of the vehicle cover of FIG. 1 and particularly illustrating an exemplary section of the vehicle cover, the array of inflatable air cells in both phantom and solid line, and a portion of a top layer of the vehicle cover fragmented to illustrate the underlying array of air cells;

FIG. 3 is a fragmented perspective view of the vehicle cover of FIG. 1 taken through line 3-3 of FIG. 2 and particularly illustrating select air cells cut away to illustrate an air conduit located throughout the array of air cells; and

FIG. 4 is an end view of a select portion of the array of air cells and particularly illustrating an air access point for connecting the air conduit located throughout the array of air cells with an air pump for supplying air to the air cells.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

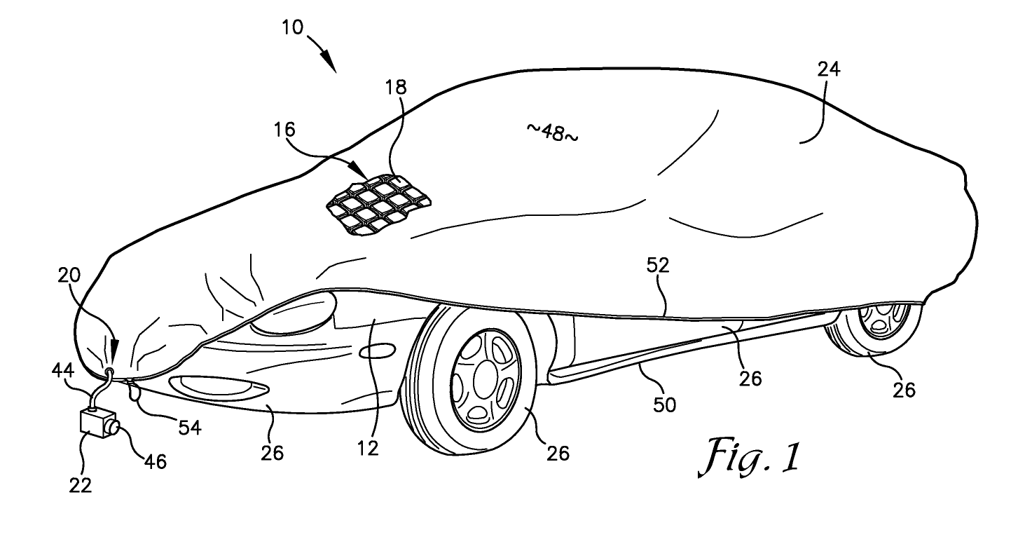

Embodiments of the invention are directed to an air-cushioned vehicle cover 10 for covering a vehicle 12 and preventing damage from large-force impacting objects, such as hail or large debris caused by a storm. The vehicle cover 10 broadly comprises a first layer 14 configured for positioning proximal the vehicle 12 and for contacting at least a portion of the vehicle; an array 16 of a plurality of inflatable air cells 18, wherein the array 16 rests upon and is coupled to the first layer 14; an air access point 20 located on at least one air cell 18 for interconnecting the at least one air cell with a source of air 22; and a second layer 24 configured for positioning distal the vehicle 12 and for facing an ambient environment in which the vehicle is located. As described in more detail below, the vehicle cover 10 is generally positioned over the vehicle 12 prior to the air cells 18 being inflated with air. Once the cover 10 is in position over the vehicle 12, the air access point 20 is coupled with the air source 22, and the air cells 18 are inflated. As best illustrated in FIG. 1, when the air cells 18 are inflated, the vehicle cover 10 fits snugly over and around the vehicle 12, such that the vehicle cover 10 contacts substantially all of the vehicle 12 and covers substantially all of the vehicle 12.

Reference to the vehicle cover 10 covering substantially all of the vehicle 12 is intended to encompass the front and back of the vehicle, the left and right sides of the vehicle, including the doors, and the roof of the vehicle. Specifically, reference to the vehicle cover 10 covering substantially all of the vehicle is not intended to encompass the undercarriage of the vehicle that faces towards the ground and a lower portion 26 of the vehicle, such as a lower end of the doors, a lower portion of the tires, etc.

Embodiments of the invention include vehicle covers 10 for covering various types of vehicles, including cars, boats, motorcycles, airplanes, recreational vehicles, etc. In alternative embodiments, the invention may be used to cover objects that reside in an outdoor environment and therefore, are vulnerable to large-force impacting objects. Non-limiting exemplary objects include fragile vegetation, such as a topiary; outdoor art installations, such as a sculpture; and glass-enclosed structures, such as a nursery or sunroom. For these various types of objects, versions of the cover having an array of inflatable air cells can be used to cover disparate shapes of objects.

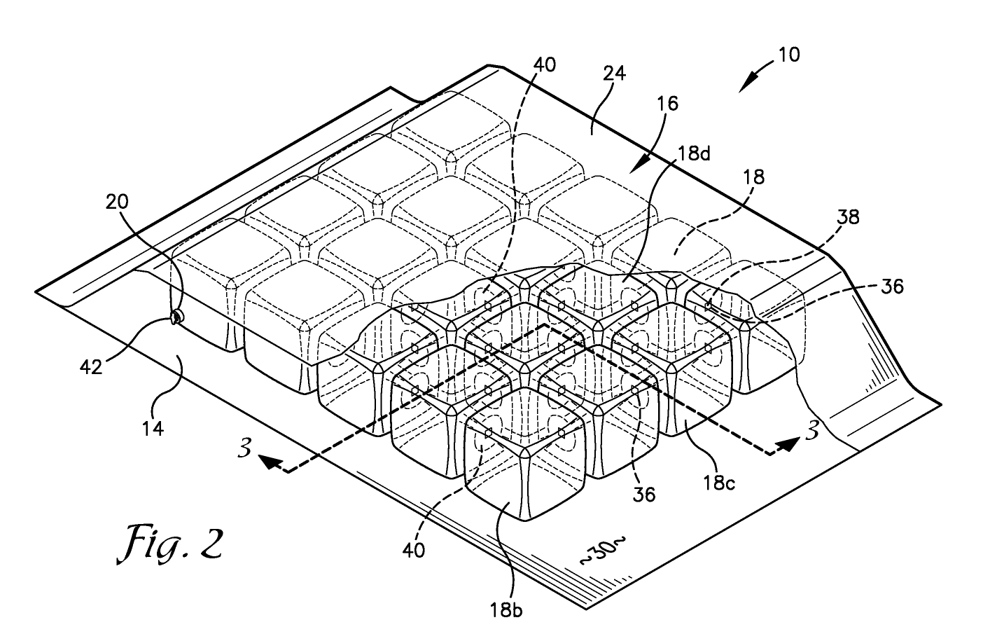

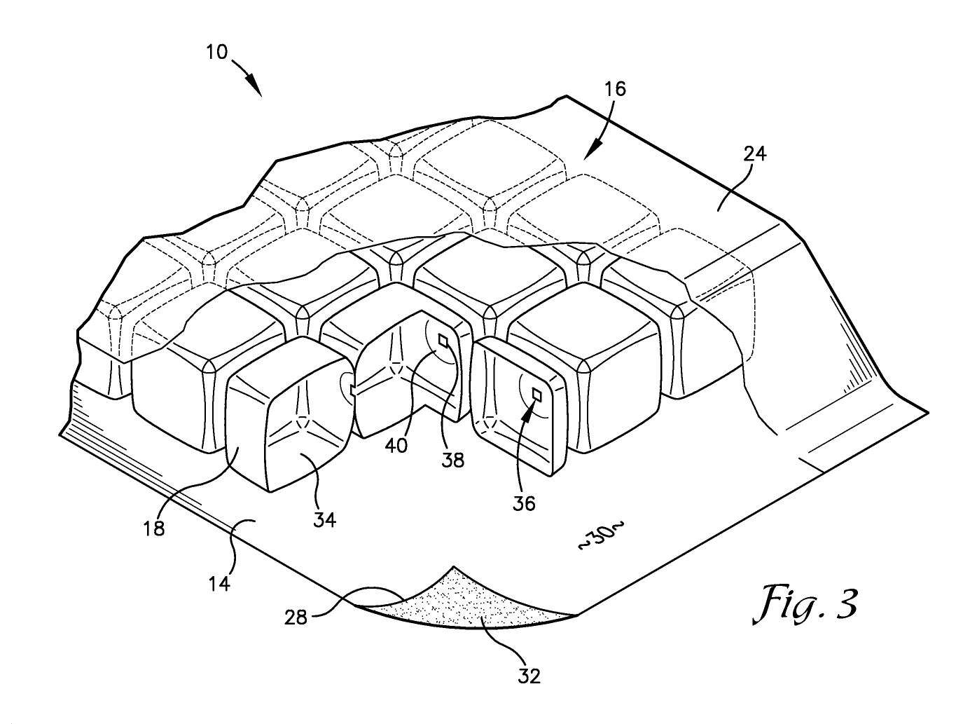

Referring now to FIGS. 2 and 3, the first layer 14 is shown supporting the array 16 of inflatable air cells 18, such that the first layer serves as a substrate for the array. Because the first layer 14 supports the array 16, the first layer is positioned proximal and adjacent the vehicle 12. That is, when the vehicle cover 10 is fitted over the vehicle in its operating position, a proximal face 28 of the first layer 14 contacts the vehicle 12 (see, FIG. 3), and a distal face 30 of the first layer 14 contacts the array 16. Reference herein to “proximal” defines the direction closest to the vehicle 12, and reference herein to “distal” defines the direction away from the vehicle. Reference herein to the first layer 14 being adjacent the vehicle 12 includes circumstances in which the first layer is proximal the vehicle but not necessarily contacting the vehicle. However, in such circumstances, the vehicle cover 10 is still tightly fitted around the vehicle 12, such that a distance between an exterior of the vehicle and the proximal face 28 of the first layer 14 is relatively small, such as less than 10 inches, less than 5 inches, or less than 3 inches.

The proximal face 28 of the first layer 14 is made from a flocked material 32 that is effective to reduce scratches on the surface of the vehicle 12 and to reduce mildew growth between the vehicle and the first layer. The flocked material 32 may comprise a velour, microfiber, or felt-type material that is soft, has a low coefficient of friction, and that will not scratch the underlying vehicle 12. Because the proximal face 28 of the first layer 14 is generally in contact with the vehicle's surface, the flocked material 32 provides an additional layer of protection from object impacts.

As noted above, the first layer 14 operates as a substrate for the array 16, and as such, the first layer 14 is sized approximately the same area as the array or slightly larger than the area of the array. At least a portion of the array 16 is secured to the distal face 30 of the first layer 14 so that the array does not easily separate from the first layer. In embodiments, the array 16 may be secured to the first layer 14 via adhesive bonding. Alternatively, mechanical attachment methods may be used, such as a plurality of grommets (not shown) located on one of the first layer or the array, and a plurality of clips (not shown) for locating through the respective plurality of grommets located on the other of the first layer or the array (not shown). In embodiments of the invention, the array 16 may be secured to the distal face 30 of the first layer 14 along a plurality of points of the first layer to effectuate little to no movement of the array relative to the first layer. In alternative embodiments, the array 16 30 may be secured to the distal face of the first layer 14 but allow for limited movement of the array relative to the first layer.

In embodiments of the invention, the first layer 14 may not be used, such that the array 16 is positioned proximal to and substantially adjacent the vehicle 12. In this embodiment, a proximal face (not shown) of the array 16 may be flocked, as discussed above, to prevent scratching the vehicle surface. In yet further embodiments of the invention, each air cell 18 may not include a proximal or bottom side, such that the first layer 14 forms the bottom of the air cell 18. In this embodiment, each air cell 18 would be secured to the first layer 14 along a proximal-most edge of the air cell to hermetically seal the air cell to the first layer at the proximal-most edge.

Referring now to FIGS. 2 and 3, the plurality of air cells 18 formed in the array 16 is illustrated. Each air cell 18 is formed of a pliable material that is configured to be inflated with air to form an internal air chamber 34 (see, FIG. 3 and cut-away of an air cell). The pliable material for each air cell 18 serves as a structural envelope of the cell. A “building envelope” is known in the art as the physical separator between an interior of a building and an exterior environment. Similarly, the “structural envelope” as used herein for each air cell 18 is defined as the pliable material that separates the internal air chamber 34 from the external environment. In embodiments of the invention, the air cell 18 is provided with at least one air conduit 36 comprising at least one opening 38 through the pliable material of the air cell, as discussed in more detail below.

In embodiments of the invention, each air cell 18 is substantially closed, such that the pliable material when expanded with air forms the internal air chamber 34. However, it should be appreciated that each air cell 18 will have the air conduit 36, as noted above. Thus, reference to the air cell 18 being “substantially closed” includes the air cell having the air conduit 36 for fluid communication of air therein.

The individual air cells 18 of the array 16 may be a variety of shapes, and in embodiments, a single vehicle cover 10 may include air cells 18 of differing shapes. In embodiments, the shape of each air cell 18 is a quadrilaterally-faced hexahedron, which is defined as a polyhedron with six faces. Exemplary hexahedra include a cube and a rectangular parallelepiped. In other embodiments, the shape of each air cell 18 may be generally curved and include a sphere, an ovoid, an ellipsoid, or a cylinder. For example, the air cells 18 may be cylindrical in shape and placed end-to-end. The shape of the air cells shown in the drawing figures is substantially the shape of a cube, but it should be appreciated that other shapes, including a combination of shapes, may be employed.

In embodiments of the invention, each air cell is relatively small as compared to an area of the vehicle cover 10 and a size of the vehicle 12. For example and in embodiments, each air cell 18 is approximately 1-50 inches in height, approximately 1-30 inches in height, approximately 1-10 inches in height, approximately 3-7 inches in height, or approximately 4-5 inches in height. Similarly, each air cell 18 is approximately 1-50 inches in width, approximately 1-30 inches in width, approximately 1-10 inches in width, approximately 3-7 inches in width, or approximately 4-5 inches in width. Each air cell 18 is also approximately 1-50 inches in length, approximately 1-30 inches in length, approximately 1-10 inches in length, approximately 3-7 inches in length, or approximately 4-5 inches in length. For air cells have a curved shape, the height, width, and length may equate to the diameter (e.g., for a sphere) or a length of the major and minor axes (e.g., for an ellipsoid).

It is desirable that the size and shape of each air cell 18 be such that when an object impacts the air cell, the air cell is of sufficiently small size and of sufficient shape to prevent air being dispersed throughout the air cell, or any fluidly adjoining air cells, to thereby allow the object to impact the vehicle. For relatively larger air cells, e.g., a single air cell covering a majority of a length of the vehicle, an object impacting the air cell will allow air held within the chamber of the cell to be translated within the chamber. This is especially true because it should be expected that the array would, over time, leak air. As air leaks out of each cell, more open volume is provided for the movement of air within the chamber, which results in the possibility of an object impacting the air cell to in turn impact the vehicle surface. Thus, the air cells should be of a shape and size to restrict the distribution of airflow that results from objects impacting the vehicle cover.

A quantity of air cells 18 comprising each vehicle cover 10 will now be discussed. For explanation and reference purposes, assume that each air cell is a 5-inch cube, such that each side of the air cell is 5 inches. The air cells are arranged side-by-side, as shown in FIGS. 2 and 3, to form the array 18, and the array comprises a plurality of rows and columns of air cells. As can be appreciated, the shape and size of the array is dependent on a type of vehicle for which the vehicle cover is to be used. For example, the array, and therefore, the interconnecting shape of the plurality of air cells, for a motorcycle will be different than the array for a car. Regardless of the shape and size of the array, in embodiments of the invention, the quantity of air cells used to form the array is approximately at least 10 individual air cells, approximately at least 25 individual air cells, approximately at least 50 individual air cells, approximately at least 75 individual air cells, approximately at least 100 individual air cells, approximately at least 200 individual air cells, approximately at least 500 individual air cells, or approximately at least 700 individual air cells. For instance, in embodiments of the invention using 5-inch cube-shaped air cells for a vehicle cover that is 5 feet wide by 10 feet long, the array comprises approximately 288 air cells. For a larger vehicle, a larger array would be required, and for a smaller vehicle, a smaller array would be required. Thus, embodiments of the invention provide for the number of air cells to be varied such that the vehicle cover 10 can fit over vehicles of various sizes and types.

The air cells 18 may be coupled together or otherwise interconnected within the array 16. In embodiments, the air cells 18 are adhesively bonded to each other about a portion of at least one external face of each air cell. For example and as shown in FIGS. 2 and 3, a coupling area 40 is shown as a circular area at approximately a midpoint of a face of the cube-shaped air cell 18. The air conduit 36 is formed through the coupling area, such that the air conduit 36 extends between two adjoining air cells 18. In embodiments, the coupling area 40 is not about the entire face of the air cell; that is, in embodiments the air cells are not coupled to each other about an entire face of the air cell. Alternatively, in other embodiments, substantially all of the faces of each air cell could be coupled to substantially all of the faces of adjoining air cells. The air cells may also be coupled together via other coupling methods, such as a mechanical method. For example and as discussed below, the air cells may be interconnected via a series of tubes (not shown) that further serve as the air conduit between each air cell. In some embodiments of the invention, the air cells may be substantially separated a distance of approximately at least 0.1 inch, approximately at least 0.25 inch, approximately at least 0.5 inch, or approximately at least 1 inch.

As noted above, each air cell 18 includes the at least one air conduit 36 for the fluid communication of air into the air cell 18. Referring to FIG. 2, depending on a location of the air cell 18 in the array 16, some air cells may include two conduits 36 (air cell 18b), three conduits 36 (air cell 18c), or at least 4 conduits 36 (air cell 18d). In embodiments of the invention, each air conduit 36 may comprise the opening 38 in a side or face of the pliable material forming the air cell 18, such that air may be fluidly communicated through the opening 38. The opening 38 may be approximately 0.1-1 inch in diameter or width. In other embodiments, air conduits 36 are provided at opposing ends or sides of each air cell 18. The air may then flow into the air cell 18 at one end, fill the air cell chamber, and then continue through and pass to the adjacent air cell 18 during inflation of the vehicle cover.

In alternative embodiments, at least one opening may be provided in the air cell, and a tube (not shown) may pass through the opening. Air is then communicated through the tube and into the internal chamber of the air cell. Adjoining air cells could then be coupled together via the tube. Each tube may be approximately 0.1-1 inch in diameter or width to correspond to a diameter or width of the opening in the face of the air cell. Each tube may also be approximately 0.1-1 inch in length, such that when two adjoining air cells are connected via the tube, a distance of approximately 0.1-1 inch separates the air cells. In a variant of this embodiment, a single tube (not shown) passes through aligned air cells, including through the internal chamber 34 of each cell. To fluidly communicate air through the tube, a segment of the tube positioned within the chamber 34 may be perforated to allow air to pass through the perforations and into the air cell chamber.

In embodiments of the invention, all the air cells 18 that comprise the array 16 are fluidly interconnected, such that air can pass through each of the air cells and to another cell. However, in other embodiments of the invention, the array 16 is fluidly divided into a plurality of portions (not shown), wherein a first portion of the array comprises a first set of air cells that are fluidly interconnected, a second portion of the array comprises a second set of air cells that are fluidly interconnected, and the first set of air cells is not fluidly interconnected with the second set of air cells. Such configuration may be desirable in the event that one of the sets of air cells is punctured or otherwise loses air, so that at least some of the air cells of the vehicle cover remain inflated. In alternative embodiments, the first and second sets of air cells are fluidly interconnected for the communication of air from one of the first or second sets of air cells to the other of the first or second sets of air cells.

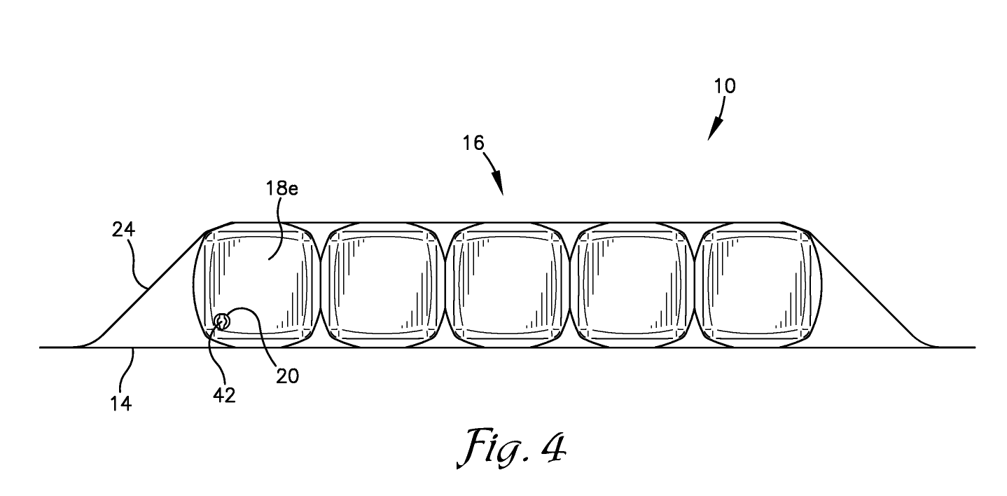

To inflate the array 16 of air cells 18, the air source 22 is fluidly interconnected with the air access point 20, as shown in FIG. 4. In embodiments, the air access point 20 is a closable valve stem 42 extending from an external air cell 18e. In embodiments of the invention that include a plurality of divided sets of air cells, two or more air access points 20 may be employed. An external air cell 18e is any air cell that is located on an outer row or column of the array 16, such that at least one side or face of the external air cell 18e is not adjacent another air cell. It is desirable to have the air access point 20 located on an external air cell 18e to allow for easy access by a user of the vehicle cover 10.

The air source 22 comprising the air pump is connected to the air access point 20 via a flexible hose 44. In embodiments of the invention, the air pump 22 may generally include any type of air or gas pump, such as a mechanical valve, rotary, diaphragm, solenoid, or other similar style of pump that is appropriate for applying air and positive air pressure to the individual air cells of the vehicle cover. In other embodiments, the pump may be electrically powered by AC, such that it may be conventionally connected to a 120V AC wall or generator outlet. In other embodiments, the pump may be powered by DC, such that it may be connected to a conventional battery or other DC power source. The pump 22 includes a pressure-actuated control switch 46, such that the pump will introduce air to the air cells 18 until a maximum pressure has been achieved. Once the maximum pressure is achieved, the pressure control switch 46 turns the pump off. If the pressure inside the first cushion layer is reduced beyond a specified amount below the maximum pressure, then the pressure control switch re-activates the pump until the maximum pressure is again achieved. The vehicle cover 10 may, in embodiments, be fully pressurized within 1-5 minutes, within 2-4 minutes, or within 3 minutes. Once the vehicle cover 10 is fully inflated while positioned on the vehicle, the cover 10 creates a substantially tight fit over the vehicle that prevents removal of the cover from the vehicle or, at the least, makes removal very difficult.

In additional embodiments, the pump may be used to withdraw air from the individual air cells. In such an embodiment, the pump is operated in a reverse direction such that it pulls the air out of the individual air cells. Once the air is removed from the air cells, the vehicle cover can be removed from the vehicle, folded up, and stored in a small storage space, as discussed in more detail below. In certain embodiments, the pump may be positioned in a pocket that is sewn onto a corner section of the vehicle cover.

Referring now to FIGS. 1 and 2, the second layer 24 is distal the vehicle 12 when the vehicle cover 10 is installed on the vehicle, such that the second layer 24 faces outwards toward the ambient environment in which the vehicle is located. The second layer 24 is generally made from an ultraviolet (UV) acceptable, high-strength vinyl. Because most vinyls are prone to photo oxidation after exposure to UV light, embodiments of the invention provide for the second layer 24 to be made from vinyl that has been treated with a UV stabilizer, which reduces or prevents physical deterioration due to UV light. A distal face 48 of the second layer 24 may also include a silver reflective finish that is effective to reflect UV light.

In embodiments of the invention, the second layer 24 is sized such that it covers the entire array 16. The second layer 24 may be secured to the array and/or the first layer 14 via the securement methods discussed above for securing the array to the first layer, such as adhesive bonding. In certain other embodiments, there may not be a distinct second layer, and the distal faces of the individual air cells may be exposed to the ambient environment and include the silver reflecting finish.

The vehicle cover may optionally include a fitting or securement system for fitting or securing the vehicle cover to the vehicle. Although various fitting systems may be employed, in embodiments of the invention, a lower-most edge of the vehicle cover 50 (i.e., the edge of the cover that is closest to the ground when the vehicle cover is fitted over the vehicle) includes a looped seam 52 through which a bungee cord 54 is positioned. An adjustable lock knob (not shown) then tightens the cord 54 so that the cover 10 remains fastened down onto the vehicle 12 during high winds. In alternative embodiments, the fitting system comprises a front strap and buckle (not shown) and a rear strap and buckle (not shown) that permits the user to strap the vehicle cover to the front and rear portions of the vehicle to secure the cover in place.

The vehicle cover 10 may be stored in a pull-cord bag (not shown), which can then be stored in the vehicle's trunk. Prior to severe weather, the cover is removed from the bag and unrolled. If the pump 22 is electrically powered, the pump may be fitted with an adapter that can be connected with the vehicle, such that the vehicle serves as a power source. The cover is placed over the vehicle in the deflated position, such that the cover lies substantially over the vehicle. The user then connects the air pump to the air access point, turns the air pump on, and allows the air pump to inflate each air cell. Once the vehicle cover is inflated, the air pump is removed (or positioned within the pocket located in the vehicle cover), the valve stem at the air access point is closed, and the bungee cord is pulled tightly around the base of the vehicle.

As noted above, the individual air cells are designed to effectively absorb and distribute the impact forces from impacting objects. Because of the size of the individual air cells and because each air cell is only connected to other air cells via a small connection point, the air within a given air cell cannot be easily forced out of an individual air chamber due to an impact force. Instead, upon impact, only a small amount of air will be allowed to transfer from an impacted individual air cell into adjoining air cells. The remaining air confined within the impacted individual air chamber acts as a pressure barrier to the impacting object, thus protecting the vehicle.

Although embodiments of the invention have been described above and with respect to the drawings, it should be appreciated that embodiments of the invention may include additional features than described above. For example, the array 16 may be a first array, and a second array comprising a plurality of air cells may be positioned atop the first array, such that the vehicle cover includes two layers of arrays. In such an embodiment, a length and a width of the second array may be substantially the same as the first array, such that the second array entirely covers the first array. In embodiments comprising the second array, the second array may comprise a plurality of small air cells, as described above for the first array. Alternative, the air cells for the second array may be significantly larger, such that the second array comprises less than 20, less than 10, or less than 5 air cells. In yet a further embodiment, the second array comprises a single air cell. A second air access point may be used for the second array.

Having thus described various embodiments of the invention, what is claimed as new and desired to be protected by Letters Patent includes the following:

1. A vehicle cover for covering a vehicle, the vehicle cover comprising:
a plurality of inflatable air cells formed in an array,
wherein the array of inflatable air cells includes at least 100 individual air cells,
wherein each air cell is formed of a pliable material that is configured to be inflated with air to form an internal air chamber,
wherein each air cell has a width of approximately 1-10 inches, a length of approximately 1-10 inches, and a height of approximately 1-10 inches,
wherein at least a first portion of the plurality of air cells are fluidly connected for the transfer of air through each of the first portion of the plurality of air cells,
wherein at least a second portion of the plurality of air cells are fluidly connected for the transfer of air through each of the second portion of the plurality of air cells; and
an air access point located on at least one air cell of said at least a first portion of the plurality of air cells for interconnecting said at least one air cell with a source of air,
wherein the vehicle cover is configured to fit securely around and cover at least a portion of the vehicle, such that at least a portion of the array is in contact with the vehicle.

2. The vehicle cover of claim 1, wherein the array of air cells includes at least one external air cell, and the air access point is located on said at least one external air cell.

3. The vehicle cover of claim 1, wherein said first portion of the plurality of air cells is fluidly connected with said second portion of the plurality of air cells for the transfer of air through each of the first and second portions of the plurality of air cells.

4. The vehicle cover of claim 1,
wherein at least a first sub-portion of air cells of said first portion of air cells includes at least two air conduits for the transfer of air therethrough, and
wherein at least a first sub-portion of air cells of said second portion of air cells includes at least two air conduits for the transfer of air therethrough.

5. The vehicle cover of claim 1, wherein each air cell, when inflated, has a shape selected from the group consisting of: a cube, a rectangular parallelpiped, a sphere, an ovoid, an ellipsoid, a cylinder, and a hexahedron.

6. A vehicle cover for covering a vehicle, the vehicle cover comprising:
a first layer configured for positioning proximal the vehicle and for contacting at least a portion of the vehicle;
a plurality of inflatable air cells formed in an array,
wherein each air cell is formed of a pliable material that is configured to be inflated with air to form an internal air chamber,
wherein at least a first portion of the plurality of air cells are fluidly connected for the transfer of air through each of the first portion of the plurality of air cells,
wherein at least a second portion of the plurality of air cells are fluidly connected for the transfer of air through each of the second portion of the plurality of air cells,
wherein at least a portion of the array is coupled to and rests upon at least a portion of the first layer, such that the first layer serves as a substrate for said at least a portion of the array;
an air access point located on at least one air cell of said at least a first portion of the plurality of air cells for interconnecting said at least one air cell with a source of air; and
a second layer configured for positioning distal the vehicle and for facing an ambient environment in which the vehicle is located.

7. The vehicle cover of claim 6, wherein the array of inflatable air cells includes at least 10 individual air cells.

8. The vehicle cover of claim 7, wherein the array of inflatable air cells includes at least 50 individual air cells.

9. The vehicle cover of claim 8, wherein the array of inflatable air cells includes at least 100 individual air cells.

10. The vehicle cover of claim 6, wherein the array of air cells includes at least one external air cell, and the air access point is located on said at least one external air cell.

11. The vehicle cover of claim 6, wherein said first portion of the plurality of air cells is fluidly connected with said second portion of the plurality of air cells for the transfer of air through each of the first and second portions of the plurality of air cells.

12. The vehicle cover of claim 6,
wherein at least a first sub-portion of air cells of said first portion of air cells includes at least two air conduits for the transfer of air therethrough, and
wherein at least a first sub-portion of air cells of said second portion of air cells includes at least two air conduits for the transfer of air therethrough.

13. The vehicle cover of claim 6, wherein each air cell has a width of approximately 1-10 inches, a length of approximately 1-10 inches, and a height of approximately 1-10 inches.

14. The vehicle cover of claim 13, wherein each air cell has a width of approximately 3-7 inches, a length of approximately 3-7 inches, and a height of approximately 3-7 inches.

15. The vehicle cover of claim 6, wherein each air cell, when inflated, has a shape selected from the group consisting of: a cube, a rectangular parallelpiped, a sphere, an ovoid, an ellipsoid, a cylinder, and a hexahedron.

16. A method of covering a vehicle with a vehicle cover, the method comprising the steps of:
providing a vehicle cover including—
a plurality of inflatable air cells formed in an array,
wherein each air cell is formed of a pliable material that is configured to be inflated with air to form an internal air chamber,
wherein at least a portion of the plurality of air cells are fluidly connected for the transfer of air through each of the at least a portion of the plurality of air cells;
an air access point located on at least one air cell of said at least a portion of the plurality of air cells for interconnecting said at least one air cell with a source of air; and
a top layer positioned over and substantially covering the array, wherein when the vehicle cover is covering the vehicle, the top layer faces an ambient environment in which the vehicle is located;
instructing a user of the vehicle cover to lay the vehicle cover, in a deflated position, substantially over the vehicle;
instructing the user of the vehicle cover to connect the air access point with said source of air; and
instructing the user of the vehicle to inflate each air cell using the source of air.

17. The method of claim 16, wherein the array of inflatable air cells includes at least 100 individual air cells.

18. The method of claim 17, wherein each air cell has a width of approximately 3-7 inches, a length of approximately 3-7 inches, and a height of approximately 3-7 inches.

19. The method of claim 17, wherein the array of air cells includes at least one external air cell, and the air access point is located on said at least one external air cell.

20. The method of claim 17, wherein the vehicle cover further includes a bottom layer, and at least a portion of the array is coupled to and rests upon at least a portion of the bottom layer, such that the bottom layer serves as a substrate for said at least a portion of the array.
